(19) United States
(12) Patent Application Publication
(10) Pub. No.: US 2009/0086025 A1
(43) Pub. Date: Apr. 2, 2009

(54) CAMERA SYSTEM

(75) Inventors: Yan Ngu, Riviera Beach, FL (US); John Zabriskie, JR., Port Saint Lucie, FL (US); Max Walter Saelzer, Vero Beach, FL (US); Rex Hodge, Riviera Beach, FL (US); James Braun, Loxahatchee, FL (US); Walter Pierce, III, Lake Worth, FL (US); Thomas J. Pavlik, Riviera Beach, FL (US); Jeffrey R. Pierce, Palm Beach Shores, FL (US); Vesna Stanic, West Palm Beach, FL (US); Daniel Agusto Betts, Parkland, FL (US); Michel Fuchs, Palm Beach Garden, FL (US)

Correspondence Address: HOWARD & HOWARD ATTORNEYS PLLC, 450 West Fourth Street, Royal Oak, MI, 48067, US

(73) Assignee: ENERFUEL, West Palm Beach, FL (US)

(21) Appl. No.: 12/134,621

(22) Filed: Jun. 6, 2008

Related U.S. Application Data
(63) Continuation of application No. PCT/US2008/006400, filed on May 19, 2008.
(60) Provisional application No. 60/997,131, filed on Oct. 1, 2007.

(51) Int. Cl. H04N 7/18

(52) U.S. Cl. 348/159; 348/E07.085

(57) ABSTRACT

A remote surveillance system (the system) of the present invention is designed to have a long independent operation, portability, and wireless transmission of digital data from any location worldwide. The system includes a hybrid power element having novel hydrogen storage and generation device, light weight polymer electrolyte membrane (PEM) fuel cell, and the low power and low weight electronics. The system also includes multiple day/night cameras, motion detector, global positioning system (GPS), and wireless module. The system is packed in a back pack case and is easily carried between multiple locations due to low weight and compacts size.

### RELATED APPLICATIONS

This is a non-provisional application that claims priority to a provisional application Ser. No. 60/997,131 filed on Nov. 14, 2007 and incorporated herewith by reference in its entirety. This non-provisional application is also a continuation in part application of a PCT patent application serial number PCT/US/2008/006400 filed on May 19, 2008 and incorporated herewith by reference in its entirety

### FIELD OF THE INVENTION

The present invention generally relates to a camera system that utilizes cellular wireless network for data transmission powered by a battery, solar cell, and the like.

### BACKGROUND OF THE INVENTION

Surveillance systems, particularly remote surveillance systems (RSS) are devices that allow businesses and individuals to monitor the objects of interest at remote locations. These devices are used in both residential and commercial areas, at shopping malls, construction sites, and border areas and virtually at any location at which it would be beneficial to monitor activities. Such systems provide security by deterring unlawful or otherwise improper activities, minimizing losses, maximizing worker productivity, identifying the causes of accidents and crimes and so forth.

The fastest growing areas of camera application are property protection, and wilderness observation. A typical surveillance device used for remote applications includes cameras for both day and night observations powered with battery or grid. Many of the currently available devices employ advanced power electronics and wireless data transmission. A shortcoming associated with conventional surveillance system is related to the power supply that must be continuous if continuous surveillance is desired. It is difficult to provide electrical power in many cases where these systems are used at remote locations. For example, it is difficult to provide power to systems desired at remote construction locations where electrical power has not yet been provided. It is similarly difficult to provide electrical power to security systems that may be desired in undeveloped regions such as along national borders. Moreover, when the security system is used to monitor multiple locations that may be spread out over acres or miles, it is even more problematic to provide power to the various locations.

However, the main limitations to their portability and longevity are imposed by the power supplies. For instance, when designed to be powered by grid, the system can be only used at locations where power grid is available. However, for remote applications where the grid is not available, batteries are used. For the system extended run-time, battery banks may become bulky, thus eliminating portability of the system. Batteries combined with solar cells are occasionally used to power the system.

Typically battery is the main power source that provides electrical energy to cameras and electronics incorporated in the system. They are recharged with solar cells when the energy content in battery reaches a minimum threshold. However, this power source requires locations where the sun irradiance is abounded throughout the year in order to be a reliable power supply.

The art is replete with various references. One of these references in United States Patent Publication No. 2003/0128130 A1 teaching a solar and battery powered wireless radio transmission security camera. To extend the independent operation at remote locations and decrease the size of the power supply, a complex control strategy was implemented to reduce the power consumption. However, the reliability of the system operation still relies on the solar irradiance. For down sized battery and solar cell, the system may not be functioning during extended period of cloudy weather.

Similar problems can be perceived for a remote surveillance system developed by the University of Missouri for observation of the agricultural fields. Their SCIRC (Self-contained Internet Remote camera) device includes wireless data transmission and cameras powered mainly by a battery. For operations longer than five days, the system includes a solar cell. As the other systems that utilize the same power sources, the main disadvantage of this system is reliability. A small battery that in turn enables the device portability, can supply power only for five days. It may discharge completely during this short period if the solar irradiance is low.

Another prior art system, such as SmartTek System offers Remote Monitoring System, a product that is mostly advertised for traffic monitoring. This system includes wireless data transmission, and is powered by a battery and solar cell. Like other systems powered by the same power sources, this system presents limited reliability. To overcome the deficiency of a monitoring system for remote applications caused by the battery and solar cell usage, two companies SFC Smart Fuel Cell, the Germany's fuel cell company, and Tedas Telecom Solutions, the Netherland's telecommunication company, jointly developed Remote Control System (RCS), a mobile and remote surveillance system with wireless data transmission that is powered by direct methanol fuel cell (DMFC). Even though the application of the fuel cell technology improved the device mobility and the length of its stand alone operation, it also encountered new problems. The intrinsic disadvantages of the DMFC technology that are the high material cost, bulkiness of the device, limited durability, and most importantly the presence of methanol, a well known hazardous compound, are now incorporated into the remote surveillance system. Indeed, to leave the large amounts of methanol stored in unattended remote locations presents a great environmental risk.

The similar platform is utilized in the remote monitoring systems developed by OkSolar. Not only that their surveillance products Ok-IP Video Anywhere have the same key elements as RCS, but they also have the EFOY, a direct methanol fuel cell made by SFC Smart Fuel Cell. In addition, their systems have limited portability due to large weight, the lightest system has 125 lbs excluding the DMFC fuel cell system and methanol storage.

Alluding to the above, Sandpiper Technologies, Inc. produces light weight portable Sentinel remote surveillance systems with multiple digital video cameras. These systems do not have the wireless technology included. For the extended operation, they may be powered with EFOY fuel cell, in addition to the battery and solar cell.

In an attempt to improve the run time of a remote surveillance system, Millennium Cell, Inc. In an attempt to improve the run time of a remote surveillance system, Millennium Cell, Inc. and Gecko Energy Technologies have developed a PEM fuel cell powered wireless camera prototype system. For Gecko's PowerSkin fuel cell, hydrogen was provided by Millennium Cell's Hydrogen on Demand sodium borohydride fuel technology. Even though the PEM fuel cells have a greater potential for this application, there are some potential problems that may exist in this hydrogen production technology. They relate to the chemical reaction used to extract hydrogen form sodium borohydride. It utilizes the water solution of sodium borohydride that although chemically stabilized, still generates hydrogen when stored over long period of time and increased environmental temperature. This water solution may also freeze at subzero environment. In addition, the reaction product may precipitate on the surface of the catalyst used to accelerate the reaction, and decrease its surface area. As a result, the hydrogen generation rate may decrease over time.

Thus, there is a constant need in camera system art for an improved camera system with integral power source to eliminate problems associated with the aforementioned prior art references.

### SUMMARY OF THE INVENTION AND ADVANTAGES

A surveillance system of the present invention is a portable device designed to operate reliably and independently at remote locations over a long period of time. In particular, a remote surveillance system (the RSS or the system) of this invention is powered by an advanced hybrid power system that enables the generation and wireless transmission of data to users. A fuel cell device is one of the components of the hybrid power system. The fuel cell device receives a hydrogen-generating composition, which consists essentially of a borohydride component and a glycerol component. The borohydride and glycerol components are present in a generally three to four stoichiometric ratio, prior to reaction. The borohydride component has hydrogen atoms and the glycerol component has hydroxyl groups with hydrogen atoms. The borohydride component reacts with the glycerol component thereby converting substantially all of the hydrogen atoms present in the borohydride component and substantially all of the hydrogen atoms present in the hydroxyl groups of the glycerol component to form the hydrogen gas.

The governing components of this invention that provide portability, and long reliable operation are polymer electrolyte membrane (PEM) fuel cell system with a novel modular fuel cell, and novel fuel system, and power electronics. The function of the RSS is to monitor the location where it is placed by taking pictures with cameras that include both day and night visions. Full color day and infra red night images can be taken under any environmental conditions. The RSS utilizes the cellular technology to wirelessly transmit the images through the existing cellular phone network. Novel web-based software specifically designed for this invention allows viewing and downloading the images.

To access the images user needs to connect to the internet and log in to the RSS website. The images can be viewed as real time or archive pictures. They can be downloaded and saved on a personal computer, or archived on the RSS server. The images can also be shared and viewed by multiple users in the same time.

An advantage of this invention is to provide a system to allow the RSS user to configure the surveillance system by logging onto a website. Using a microcontroller specifically programmed for this invention to interact with a cellular device, the RSS receives commands from and sends data back to the website wirelessly. The microcontroller is programmed to receive commands from the website once it is turned on and reacts accordingly to the parameters set by the users. Image resolution, mode of operation, and duration of the session that the camera will stay on can be defined by the user. In addition, the user can set the camera remotely to take pictures only when motion is detected, or at the certain time, or to work continuously.

Another advantage is to provide a system whereby the user may have multiple RSSs placed at various remote locations. The images taken by each RSS are saved in separate files on the server. Each RSS can be located by GPS and the images generated accessed through the website. The main user may select the number of RSS viewed, and the number of users or guests able to share the images.

Still another advantage of the present invention is to provide a system adaptable to transmit data wirelessly through the cellular technology. Machine to machine (M2M) technology that is the base of this invention can be easily transformed to any other application.

Still another advantage of the invention is the advanced hybrid power system that powers the RSS that compromises of a solar cell, battery, and hydrogen PEM fuel cell system. The battery is the main power provider to all electrical power consumers in the RSS. The solar and PEM fuel cell system recharge the battery when it reaches a predetermined state of the charge threshold. The PEM fuel cell system with on board hydrogen generator provides the energy necessary for the RSS long-term uninterrupted operation.

Still another advantage of the invention is to provide a novel PEM fuel cell that has simplified design, assembly and manufacturing, and lower cost. In particular this invention provides a PEM fuel cell module having a symmetrical arrangement of two individual fuel cells with respect to a central single fuel manifold. In addition the module is assembled utilizing procedures that allow for a broad dimensional tolerance of the fuel cell components. The fuel cell module may have a passive supply of reactants through open structure anode and cathode plates, and may operate without active humidification, heating/cooling. It is a light-weight portable device that may generate minimum 0.1 W/cm² at room temperature and pressure. Each module referred to in this invention as Sym-Cell, is an assembly of one fuel manifold, two membrane electrode assemblies (MEAs), and two pairs of anode and cathode current collector plates. The fuel manifold is a central component of the module with two fuel cells being built upon its faces. Anode plates attached to the manifold by gluing, support MEAs. The module assembly is completed by affixing cathode collector plates via bolts or some other means to the opposing faces of the module. The integration of a single manifold per two fuel cells improves the design of fuel cell by reducing its complexity and bulkiness thereby reducing the number of parts, and weight of fuel cell.

Still another advantage of this invention is to provide a single manifold for fuel supply to multiple fuel cells. A central manifold provides the fuel to the fuel cells through open structure anode current collector plates. Fuel is supplied and removed from Sym-Cell through an inlet and outlet incorporated into the manifold. External manifolding is used to supply and exhaust fuel from the module simplifying the complexity of module assembly.

Still another advantage of the present invention is the sealing of the fuel cell without compressive force. Sealing of the fuel manifold is achieved by gluing the anode plate and MEA to the manifold. In particular this advantage allows for a usage of components with wider dimensional tolerance manufactured by simplified high production processes that may include molding, gluing, lamination, and cutting. Additionally, an advantage of the invention is more reliable adhesive sealing due to the enhanced bonding achieved by selecting sealant and manifold material that contain the same base polymer. The material compatibility at the bond interface improves the seal resistance to the mechanical and thermal stresses imposed by the operation of the fuel cell.

Still another advantage of the present invention is that the open structure conductive plates may be made as multi layer composites with improved corrosion resistance and electrical conductivity thereby reducing material and manufacturing cost of fuel cells. This is achieved by bonding thin layers of more electrically conductive and corrosion resistant material with a conductive adhesive to the open structure current collector plates made of inexpensive commercially available materials.

Still another advantage of the present invention is that Sym-Cell has the unconstrained design applicable to the wide range of operating conditions thereby being a universal platform for low cost PEM fuel cells. More specifically, Sym-Cell can be made to operate either as a low temperature PEM fuel cell, or as a high temperature PEM fuel cell depending on the selection of polymer electrolyte membrane in MEA, and materials of other components.

Still another advantage of the present invention is a novel fuel system used to store and generate hydrogen onboard of the RSS. In particular, this invention covers a hydrogen storage and generation system that produces hydrogen using the reaction of chemical hydride, and glycerol or glycerol containing mixtures.

Still another advantage of the present invention is that catalyst is not required for hydrogen evolution thus excluding potential problems that impede the current hydrogen storage and production technology that are based on chemical hydride-water chemistry. However, if necessary, the new hydrogen release chemistry may be combined with a solid or liquid catalyst to accelerate the hydrogen release.

Still another advantage of this invention is that the hydrogen release rate is scalable, meaning that the rate of hydrogen generated can be controlled by using other means than catalysts such as, but not limited to, by changing reactant concentrations, adding or subtracting heat from the reaction chamber, mixing or agitating the reactants during the reaction, and/or by changing the diffusion characteristics of the reactants through changes in reactant temperature and/or pressure, reactant viscosity, and addition of surfactants.

Still another advantage of this reaction is that the reaction temperature may be controlled internally. Specifically, reaction temperature may be varied by the concentration of additives included into the reaction. If necessary to accelerate the reaction, a small amount of an additive is added to react exothermally with chemical hydride and instantaneously generate heat high enough to activate the reaction of chemical hydride and glycerol. Since exothermic, this reaction is self sustained and will continue at desired rate. On the other hand, if necessary to slow down the reaction rate, a waste from waste container may be added into the reaction chamber to absorb the excess heat and thus decrease the reaction temperature increase.

Still another advantage of the present invention is increased safety and shelf life due to storing reactants in separate containers. In particular, hydrogen is formed only when the reactants are combined in reaction chamber when hydrogen is needed by fuel cell. Containers used are made of chemically compatible materials that protect chemical hydride and liquid glycerol reactant from undesirable reactions. Moreover, the containers are placed into separate cartridges that provide additional protection to the chemicals.

Still another advantage of this invention is that the reactant cartridges can be replaced easily on site without time down in the device operation. In particular, when the reactants are consumed, empty cartridges can be taken out and sent for recycling, while the new ones are installed without interruption of the device operation. In addition, the cartridges provide an extra safety feature for remote unattended operation of the device protecting the environment from getting into contact with the chemicals.

Still another advantage of this invention is the way the chemical hydride is stored. Specifically, the predetermined unit dosages of a dry solid chemical hydride that may include powder, granules, or pellets, are packaged using a strip or blister packaging method. The continuous strip packages are made from chemically resistant and impermeable foils that are sealed to protect the solid chemical hydride from the uncontrolled reaction with compounds potentially present in environment such as water or water vapor or any other chemical. In addition, the size of the packages may be scaled up and down, depending on the amount of hydrogen required to be generated at the time.

Still another advantage of this invention is that different types of cartridges may be used to accommodate the strip packaged solid chemical hydride. In particular, the designs may have different shapes and dimensions that allow for the most efficient strip packaging. In addition, the release and/or dispensing mechanism may also be included in the cartridges.

Still another advantage of this invention is that hydrogen is not present in the system unless required by fuel cell. In particular, the excess of generated hydrogen is only temporarily stored in a low pressure collapsible container until the fuel cell operates. Once the fuel cell is turned off, the unconsumed hydrogen is purged out from the system.

Still another advantage of this invention is design that enables usage of light weight and low volume components that increase the total system efficiency. In particular, low operating pressure and temperature allow for using advanced engineering materials based on polymers that are durable and inexpensive, and result in balance of plant less than 30% by weight of the total fuel system.

Still another advantage of the present invention is to provide a system that works within a wide temperature range. In particular, the usage of glycerol eliminates the problem of the current technology that relates specifically to subzero temperatures. As freeze tolerant, glycerol still can flow at temperatures below 0° C.

Still another advantage of this invention is to provide an improved power management of a camera system that includes three power devices achieved via a complex control scheme designed for this system to ensure uninterrupted power supply and safe hydrogen production. The system of the present invention is directly powered by a battery that in turn is charged either by solar cell or fuel cell depending on solar irradiance. The control of the power system consists of microcontrollers, and sensors. One of the microcontroller checks the state of the battery charge and if low it turns on either solar cell, or fuel cell to charge the battery. The solar cell produces most of the power necessary to recharge the battery. However, if the solar irradiance is low, the microcontroller turns on the fuel cell system. In addition the microcontroller also controls the hydrogen generation by measuring pressure in the hydrogen overflow container. The power electronics system is designed to save energy by placing some of the electronic components in a sleep mode when not in use.

The method of generating power as set forth in the present invention provides for increased hydrogen formation relative to conventional hydrolysis reactions and systems. The method of the present invention employs an alcoholysis reaction between the borohydride component and the glycerol component to form the hydrogen. Generally, the alcoholysis reaction does not require a catalyst component for forming the hydrogen. Further, water is generally not necessary. Not using the catalyst component and water can be useful for preventing fouling problems and for reducing costs, and is useful for forming increased amounts of hydrogen. The fuel cell device of the present invention supplies hydrogen in various quantities, and can be used to supply hydrogen when required such as to a device using a hydrogen fuel cell. The alcoholysis reaction of the present invention can also form by-products, which can be useful in various industries, e.g. pharmaceutical and chemical industries. The present invention also provides simple, scalable, and efficient methods for increasing and controlling hydrogen formation, examples of such control methods include temperature changes, pressure changes, and viscosity changes, mixing the composition, and/or use of catalyst, surfactants, and pH components. Due to the alcoholysis reaction of the present invention, if acids are employed, amounts of acid can be reduced relative to conventional hydrolysis reaction systems.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a remote surveillance camera system (the system) of the present invention incorporated into a back pack;

FIG. 2 is an environmental view of the system of FIG. 1 installed on a tree at a remote location;

FIG. 3 is a top level diagram of the system;

FIG. 4 is an exploded view of Sym-cell module of the system;

FIG. 5 presents a graph illustrating an average polarization curve of the Sym-cell module of FIG. 4 when operated with hydrogen and air at room temperature and ambient pressure;

FIG. 6 illustrates a schematic view of an inventive hydrogen storage and generation device with a batch device of the fuel cell that produces hydrogen from chemical hydride and liquid glycerol reactant;

FIG. 7 illustrates a chemical hydride cartridge;

FIG. 8 illustrates a flow chart of the hydrogen production procedure;

FIG. 9 illustrates a schematic view of turn on and turn off modes of the system;

FIG. 10 illustrates a case diagram of the system of the present invention;

FIG. 11 illustrates a deployment diagram of the system of the present invention;

FIG. 12 illustrates a diagram of the wireless electronic and data modules components of the system; and

FIG. 13 illustrates a schematic view of functions programmed into the data management microcontroller.

### DETAILED DESCRIPTION OF THE INVENTION

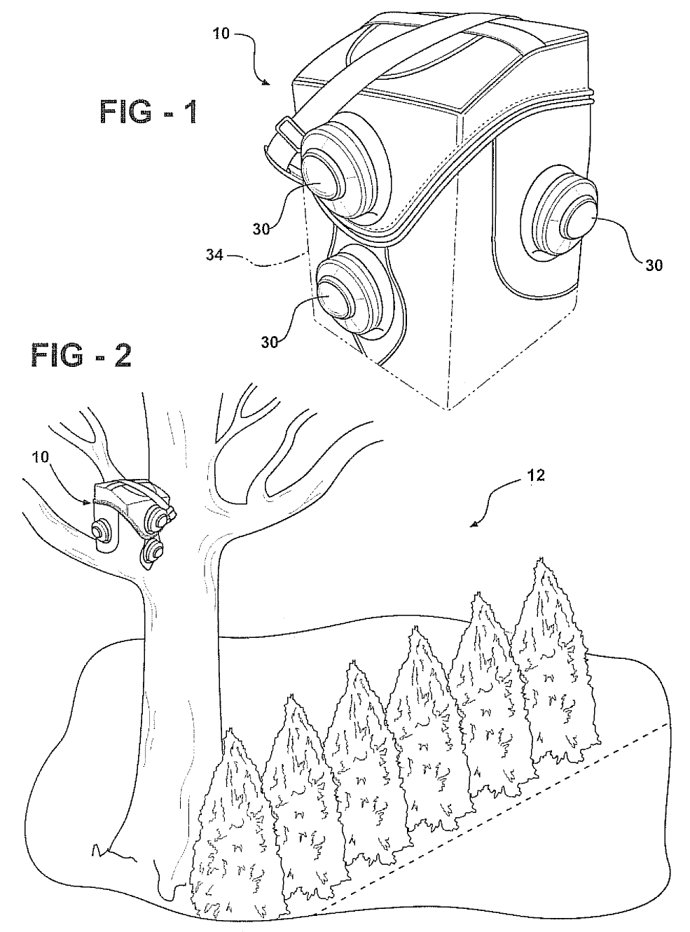

Referring to Figures of the present invention, wherein like numerals indicate corresponding parts, a stand-alone remote surveillance system (the RSS or the system) of the present invention is generally shown at 10 in FIGS. 1 and 2. The RSS 10 is designed to monitor remote areas, generally shown at 12 in FIG. 2, wherein the system 10 is located over extended run time. The system 10 design also allows for its portability and wireless data transmission. The system 10 powered by a hybrid power system includes and is not limited to a battery 14, a solar cell 16, a PEM fuel cell 18 and a fuel system 20. The system 10 operation is managed by power electronics mechanically supported and electrically connected by three printed circuit boards that include power management board 22, a sensor board 24, and a data management board 26.

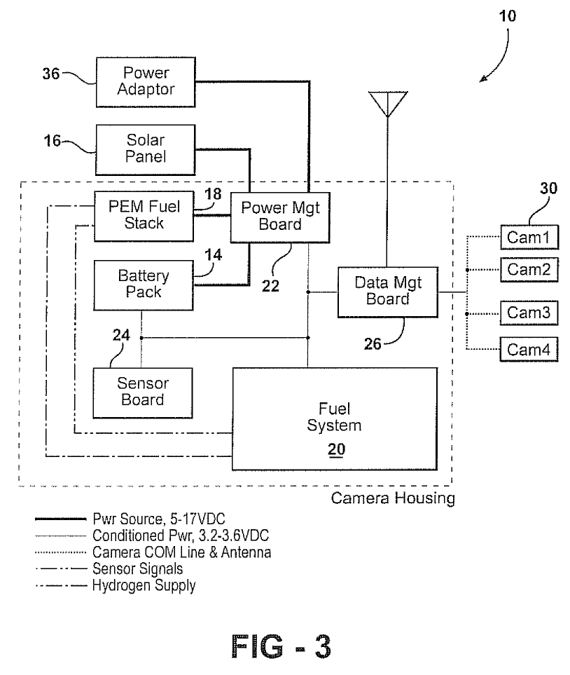

One of the main functions of the system 10 is to monitor constantly the surrounding area 12. This function is achieved by generating a continuous stream of images taken by cameras 30 and wirelessly transmitted to a user 32 of the system 10. Both day and night vision images are typically incorporated within a single camera 10. Day vision images have a full color while the night vision images usually have the shades of one color that provides a good image resolution. The type of the camera 30 may be any of the available technologies for capturing the images digitally. The cameras 30 are operable connected to the data management bored 26. All the components of the system 10 are placed within a housing, shown in phantom at 34 in FIGS. 1 and 3. The housing 34 is designed to secure and protect the system 10 components from the extreme weather conditions or mechanical damages. It also enables the users to carry the system 10 to the desired locations 12. The housing 34 is typically made of light weight durable materials that may include the polymer based fabrics and engineering plastics. The shape, type of material used to make the housing 34 is not intended to limit the scope of the present invention. For the applications where extreme thermal and mechanical stresses are probable, the housing 34 may be a casing made of metal or composite material. A power adapter 36 may be may be attached to the housing 34 to supply 12V DC power.

Alluding to the above, a hybrid power system provides electrical power to the camera devices 30, power electronics, and other electrical components such as pumps, valves, and motors used in the device. Two configurations of the hybrid power system may be used to power the system 10. One configuration may comprise the battery pack 14, a solar panel 16, the PEM fuel cell 18, and the fuel system 20 as shown in FIG. 3. The second power system (not shown) may include only the battery pack 14, the PEM fuel cell 18, and the fuel system 20. The type of the power sources and combination thereof is not intended to limit the scope of the present invention.

Alluding to the above, the operation of the hybrid power system is managed by the power electronics included in the power management board 22 and the sensor boards 24 that are operably connected to the power sources 14, 16, 18 and 20. The battery pack 14 is an energy conversion device that converts chemically stored energy into electrical and thermal by electrochemical process. It is electrically connected to the power management board 22 where it interfaces with the solar cell 16 and the PEM fuel cell 18. The battery pack 14 is one of the power supply sources of the electrical power to the system 10. When it reaches the minimum charge level, it is recharged either by the solar panel 16, or the PEM fuel cell 18. The battery type used in the system 10 may be any commercially available with electrochemistry that enables the high efficiency of charge/discharge cycles. As an example, lithium ion batteries may be used in this invention. The solar cell 16 is an energy conversion device that converts light energy into electrical energy and heat. It is functionally connected to the battery 14 and sensor board 24 via the power management board 22. Its main function is to recharge the battery 14. The solar cell extends the system 10 operation time by charging the battery instead of the fuel cell, whenever the solar irradiance is high enough to use it. This way hydrogen is saved to be used only when the solar irradiance is low. Alternatively, the solar cell may be excluded from the systems where the long operational time is not critical. The solar cell used in this invention is a commercially available product selected for this system 10 due to high efficiency.

The PEM Fuel Cell System used in this invention includes the PEM fuel cell 18, the fuel system 20, and its respective controls. Fuel cell in general is an energy conversion device that uses hydrogen as a fuel and air as an oxidant to generate electrical power, heat, and water. Hydrogen is stored onboard of the system 10 in the fuel system 20. The fuel cell 18 is connected to the hydrogen system 20 with gas lines. Oxygen is supplied to the fuel cell 18 from air by convection. The operation of the fuel cell 18 and the fuel system 20 is managed and controlled by the power electronics included in the power management board 22 and the sensors board 24. The PEM fuel cell system is the key element for the system's long run operation. This current invention encompasses a novel fuel cell 40 design, and the fuel system 20 design as described in details hereafter but not limited to the embodiments included.

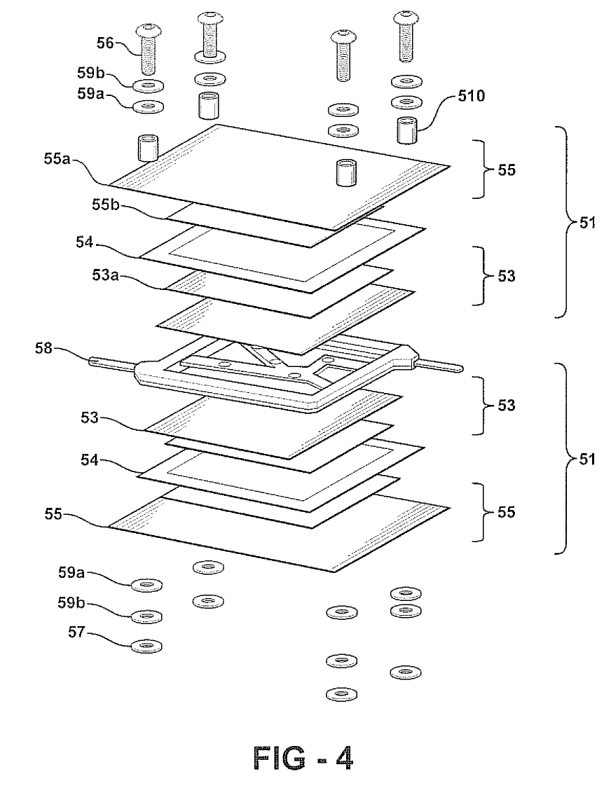

The PEM fuel cell 18 is further defined by a Sym-Cell module as shown in FIG. 4 at 50. The Sym-Cell 50 is a module that includes two fuel cells and single fuel manifold. This design allows wider dimensional tolerance and fewer number of the fuel cell components, resulting in simpler manufacturing and lower fuel cell cost. The module 50 includes two individual polymer electrolyte fuel cells 52 arranged in mirror symmetry with respect to the central fuel manifold plate 52. Each PEM fuel cell 52 includes of an anode current collector plate 54, a membrane electrode assembly (MEA) 56, and a cathode current collector plate 58. The module 5 is assembled on the opposing faces of the fuel manifold 52. Anode collector plates 53 and MEAs 54 are bonded to the fuel manifold 52 by adhesive first, and then the cathode collector plates 55 are attached to with bolts 56 and nuts 57 to complete the module 5 assembly. Hydrogen is supplied to and exhausted from two fuel cells 52 via inlet and outlet ports 58 located in the single fuel manifold 52. The open designs of the anode current collector plates 53 and cathode current collector plate 55 allow the transfer of fuel and oxidant, respectively, to and from the MEAs 54. The fuel cells 51 are electrically isolated with the manifold 52, non conductive washers 59, and plastic shrink tubes 510 placed over the bolts 56. A central fuel manifold 52 introduces, distributes, and exhausts fuel with or without water vapor from the MEA 54 anode surfaces. In addition, it electrically insulates the fuel cells 51, as well as supports the adjacent fuel cell components mounted on its opposing faces. When fuel enters into the manifold 52 it is further distributed across its flow field located on its faces. Those skilled in the fuel cell art will appreciate that various flow field types may be used for distributing the fuel at the desired fluid flow properties. These flow fields include and are not limited to channels in different configurations, corrugated, porous or perforated plates, meshes, screens, beam structures, or the like. The flow field of manifold 52 shown in has an open and quite simple design that consists only of the structural beams that support anode current collector plates 53.

In addition, the flow field provides a plenum for water droplets to form, grow, and flow under gravity, where such strategy is applicable for liquid water removal. However, a wicking media (not shown) may also be disposed within the flow field for preventing anode flooding. The central fuel manifold 52 is typically made from non conductive materials. They may include plastics made of thermoset or thermoplastic polymers, or polymer-metal composites. However, the inlet/outlet port tubes 58 may also be made of metals or metal alloys. The material selection is primarily based on the material resistance to the mechanical, thermal, and chemical stresses present in the operational fuel cell. In addition, an important factor for choosing a proper material is compatibility with the adhesive used for bonding the anode plate 53 and MEA 54 to manifold 52. Preferably the manifold 52 and adhesive are made of the same base polymer. The manifold 52 can be produced by utilizing various processes known for the manufacturing of plastics and plastic composites. They may include but are not limited to injection molding, thermoforming, casting, compression molding, and transfer molding. The fuel cell module 5 has two anode collector plates 53 placed on each face of the manifold 5

The anode collector plates 53 are designed to conduct current and transport the fuel from the flow field to the MEA 54 anode. The anode plates 53 may consist of two flat rectangular components. The first 53a component is an electrically conductive open structure layer made of corrosion resistant materials such as metals, metal alloys, or carbon based composites. They may include porous or perforated plates, screens, or meshes. The second component 53b is bonded on the anode plate 53a surface facing the MEA 54. The layer 53b may be made of a flexible graphite material. The graphite 53b is bonded to the first one 53a with a conductive adhesive. The area of the graphite layer 53b is typically the same as the size of the gas diffusion layers of the MEA 54. The purpose of the graphite layer 53b is to improve the electrical contact between the anode current collector plate 53 and MEA 54 and to increase the corrosion resistance of the plate 53a. The components of the anode current collector plate may be manufactured from commercially available materials such as SS 316 and Grafoil®. The anode plates 53 manufacturing procedure includes simple steps such as cutting, cleaning, chemical etching, bonding, and painting. For example, the pieces from a perforated metal plate and Grafoil® are first cut to the desired sizes. Then the metal plates are cleaned in ultrasonic bath, and ten chemically etched. An eclectically conductive adhesive is coated over the metal plate and the Grafoil® layer 53b is positioned over it. The adhesive may be applied by brushing, spraying, or screen printing. The assembly is compressed by clamping and placed at temperature to cure. Bonding process may be done in a heated press as well, or by any other means that involve compression and temperature control. When bonded, Grafoil® is stamped with a tooling that has pins arranged in the same pattern as the openings in the perforated plate 53a. The pins have diameter smaller than the openings in the plates 53a and are able to push and cut the Grafoil® in the openings. The final step in manufacturing is painting of the plate 53a. In this step Grafoil® is first masked by a tape and then the rest of the metal plate 53a is painted with a corrosion resistant paint. The anode collector plates 53 are inserted into the manifold recess and glued to it. The longer side of the anode plate 53 is sealed with the adhesive. The excess of adhesive bead placed over the flat area penetrates through the plate 53 openings thereby creating the seal between the anode 53 plate and the manifold 52. The adhesive is removed from the anode top surface before the whole anode plates/manifold assembly is compressed and left to cure. When mounted, one side of the anode plates 53 surpasses the manifold 52 edge for electrical wiring. The MEAs 54 consist of ion exchange membrane coated with electrode catalyst layers (not shown) and gas diffusion layers (GDLs) that may or may not be attached to the coated membrane. In particular the MEAs 54 used in this invention have GDLs attached to its opposing faces. The active area of MEA 54 coincides with the electrode area. However, GDLs may have the same size as the electrodes or they can be slightly larger than them. The active area of MEA 54 is surrounded with uncoated membrane. In the preferred embodiment the membrane surface facing the anode current collector plate 53 is used to seal the hydrogen manifold 52. The membrane may be as wide as it is needed to get a reliable sealing. The MEAs used in this invention may be obtained commercially from various vendors or they may be made in-house from the similar materials. They may be prepared by various methods known in art for manufacturing MEAs for PEM fuel cells. To seal the hydrogen manifold 52 with the MEA 54, it is bonded to the manifold after the anode plate 53 is mounted. The MEA 54 is bonded with a thin layer of adhesive applied onto the peripheral surface of the manifold 52 and the anode plate 53. One MEA 54 is positioned at the time over the anode plate 53 such that the anode GDL overlaps Grafoil® 53b while the uncoated membrane is laid over adhesive.

When both MEAs 54 are in place, the whole assembly is compressed to complete the setting of the adhesive. In the preferred embodiment both the manifold 52 and adhesive contain the same base polymer in order to enhance bonding and the manifold 52 sealing. The adhesive can be applied using brushing, spraying, or screen printing, or any other deposition technique that enables to control the adhesive layer thickness and width. To complete the Sym-cell module 52, cathode current collector plates 55 are placed on the cathode faces of the MEAs 54. The plates 55 are designed to conduct current and distribute the oxidant to the MEA 54 cathode catalyst. The cathode current collector plates 55 may consist of two flat rectangular components similar to the anode plates 53. The first plate 55a may be a porous or perforated metal plate, screen, or mesh, made of an electrically conductive corrosion resistant metal or metal alloy. On the surface facing the MEA 54 cathode side the second component 55b is placed over the plate 55a. This layer 5b is typically made of a flexible graphite based material. The area of the graphite layer 55b is the same as the cathode GDL. The purpose of the graphite layer 55b is to improve the electrical contact between the cathode plate 55 and MEA 54 and to increase the corrosion resistance of the metal plate 55a in contact with the MEA 54. The cathode plate 55 is typically manufactured form a commercially available materials such as perforate stainless steel plate and flexible graphite foil Grafoil®.

In the preferred embodiment the cathode plate 55 manufacturing procedure includes cutting, drilling, cleaning, chemical etching, bonding, perforation, and painting. For example, two pieces of a metal plate and two pieces of a graphite foil are first cut to the required sizes. Four holes are then drilled at the corners of each metal plate 55a. The plates are then cleaned in ultrasonic bath, and after that chemically etched. Electrically conductive adhesive is coated over the etched metal plate before Grafoil® 55b is positioned. The assembly is compressed by clamping and placed at temperature to cure. Bonding process may be done by a heated press, or by any other means that involve compression and temperature control. When bonded, Grafoil® is perforated with a tooling that has pins arranged in the same pattern as the openings in the plate 55a. The pins have smaller diameter than the openings of the perforated plate 55a thereby when the tooling and the plate 55 are compressed, the pins push and cut the Grafoil® 55b trough the openings in the plate 55a. The final step in the cathode plate manufacturing includes painting of the plate 55a not covered with the graphite layer 55b. Grafoil® 55b is first masked by a tape and then the metal plate is painted with a corrosion resistant paint.

When dried, the cathode plates 55 are assembled with the rest of the module with bolts 56 and nuts 57. Minimum four bolts 56 are used to keep the whole module intact. Plastic shrink tubes 510 are placed over the bolts 56 before they are locked in with nuts 57 to keep both anode and cathode of each cell and two fuel cells 51 electrically insolated. In addition, plastic washers 59a are used with the same purpose. To keep the compression in the stack unchanged over run time the lock-in washers 59b are placed between plastic washers 59a and the cathode plates 55 of each fuel cell 51. The compression of the stack with the cathode plates 55 provides a good electrical conductivity and mechanical strength to the entire Sym-Cell module 5.

When assembled the cathode plates 55 surpass the rest of the module edge for the electrical wiring. Sym-cell modules 50 may be stacked in various manners to get a fuel cell with a higher power output. For example, in the system 10 they are arranged in an array of three individual modules 50 attached to a structurally supportive light weight frame without being in a direct contact. However, in another embodiment the Sym-cell module 50 arrangement may include the stacking of the individual modules 50 into a fuel cell stack where the modules 50 are kept apart with an electrically non conductive open structure separator. The modules 50 are integrated into the stack also with a light weight supporting frame. Still another embodiment of the module 50 stacking may include a planar arrangement where the individual modules 50 are placed side by side in one plane. They may be incorporated into a planar module with a structurally supporting light weight frame as well. However, in any of the module arrangements described, the hydrogen supply still is externally supplied via existing inlets and outlets in the fuel manifold 52.

When placed in fuel cell, the hydrogen gas approaches anode catalyst while oxygen approaches the cathode catalyst of the MEA 54. Protons formed on the anode catalyst are conducted through the ion exchange membrane to the cathode catalyst where they combine with the reduced oxygen and generate water, electrical current and heat. Hydrogen coming into the tightly sealed manifold 52 is distributed through the flow field across the MEA 54 anode surface. The flow of hydrogen in the module 50 may be trough flow, or dead ended with the periodic purge since the hydrogen exhaust contains mostly water vapor. The transfer of oxygen from air occurs via convection through the open cathode structure.

The Sym-cell module 50 may operate in wide range of temperature, pressure, relative humidity, and flow rates. For example Sym-Cell operates as low temperature PEM fuel cell if Nafion® type polymer electrolyte membrane is used as an ion exchange membrane for making MEAs 54. However, Sym-Cell becomes a high temperature PEM fuel cell if the MEA 54 includes an appropriate high temperature proton exchange membrane. According to the temperature range used some other materials may be accordingly selected. They may include the fuel manifold 52 material, sealing adhesive, electro conductive bonding adhesive, and corrosion resistant paint. This is an example of the Sym-Cell operation that demonstrates the scope of this invention. It shows the performance of a Sym-Cell module when it operates at ambient temperature and pressure with a passive reactant supply. No active humidification or cooling is provided during the module operation.

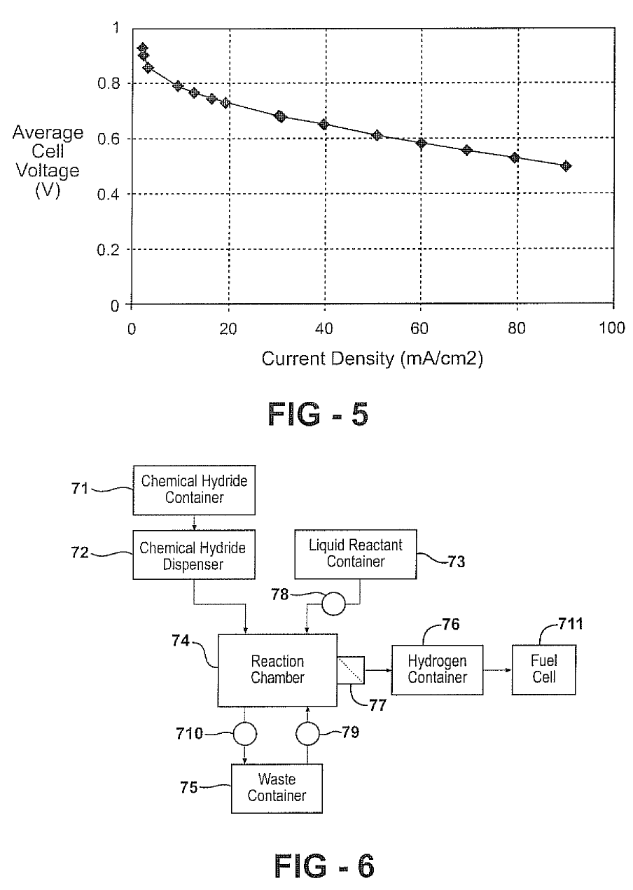

Referring to FIG. 5, the fuel system 20 is a hydrogen storage and generation device that utilizes a new chemical process for hydrogen production. The process is based on the alcoholysis reaction of chemical hydrides. The invention can take the form of various embodiments. Foremost among these are the one described in this section. A batch type reactor where stoichimetric quantities of both reactants are combined at the time. The device includes a chemical hydride container 71 that has a functional connection with a chemical hydride dispenser 72. A reaction chamber 74 is operable connected to the outlet port of the dispenser 72. The liquid reactant is stored in a container 73, and connected to the reaction chamber 74 with a fluid line. A pump 78 is used for dispensing the liquid reactant into the reaction chamber 74. Two fluid lines connect the reaction chamber 74 with a container 75 used to collect the reaction waste. One of the lines conveys waste removed from the chamber by pumping with a pump 710. The second line transports the waste back into the chamber 74 when pumped with a pump 79. The hydrogen a gas line connects the chamber 74 with a liquid-gas separator 7, and hydrogen overflow container 76 that supplies the gas to fuel cell 711 and the like. In another embodiment (not shown) the simplified device is comprised of a chemical hydride container 71, chemical hydride dispenser 72, liquid reactant container 73, liquid-gas separator 77, and hydrogen overflow container 76. The liquid glycerol reactant container 73 is a reactant chamber and waste container at the same time.

Still another embodiment may also have the same design except hydrogen flow path. In this embodiment the hydrogen gas enters the waste container 75 after exiting the reaction chamber 74, and than passes through the separator 77, and hydrogen container 76 prior entering into the fuel cell 711. As an example described in the present invention, sodium borohydride pellets are used as a solid chemical reactant for hydrogen production. One gram pellets are strip packaged (not shown) where each pellet is wrapped in a pocket of a packet that is a part of a continuous strip of laminated webs. The pellets are enclosed between two laminated webs of either the same or different materials that offer high degree of protection from environment.

A strip may consist of a bottom and top laminates wrapped around pellets and heat sealed. Similarly, the pellets may also be organized by blister packaging. The procedure is similar to the strip packaging with the only difference that the bottom laminate is preformed by either thermoforming or cold forming, and than the lid material is sealed to the one on the bottom. The strip packaged pellets are stored in a chemical hydride container 71. The strip can be packed in a zigzag formation or wound on a spool (not shown). Solid chemical hydride dispenser 72 releases a solid chemical hydride from a strip package and dispenses it into a reaction chamber. Chemical hydride container and dispenser are made of materials that are chemically, thermally and mechanically resistant at the operating conditions. Typically the materials used for manufacturing containers and dispensers may include polymers, plastics, polymeric composites, and if necessary metals and metal alloys. The operation of the dispenser 72 is controlled by electronic devices placed on the power management 22 and sensors 24 boards. The dispenser 72 is activated by electrical impulses transferred to a dispenser solenoid valve or a motor 719. The container 73 shown in stores a glycerol based liquid reactant used for hydrogen generation. The glycerol based liquid reactant is dispensed from the container 73 into a reaction chamber 74 at a predetermined volume.

Pumps such as diaphragm, peristaltic, or elastomeric may be used to dispense the exact volume of the liquid glycerol reactant. In addition a predetermined volume can also be dispensed by other means including valves with flow meters, switches, and sensors. The liquid container 73 may be collapsible and made of plastic based impermeable materials resistant to the operating pressure, temperature and chemicals. When the liquid reactant is completely consumed form the container 73 it collapses and even flattens. The dispensing of the liquid and solid reactants into the reaction chamber 74 is set with a predetermined time delay with the pellets being placed first and the liquid the second once the chamber 74 is closed. When the liquid reactant and solid chemical hydride are combined in the reaction chamber 74, they react and produce hydrogen.

The chamber 74 may present various designs without limiting the scope of the present invention. It may consist of top and bottom halves, with a gate valve for dispensing solid reactant attached to the top (not shown). Fluid lines for transporting liquid reactant, hydrogen and waste in and out of the chamber 74 are connected to it. Check valves (not shown) are installed on the lines to stop the fluids from flowing back into the chamber 74. An additional line for a pressure check valve may also be attached to the reaction chamber 74. Materials typically used for making the chamber 74 and the fluid lines are resistant to corrosion, operating pressure and temperature and may include plastics, polymer composites, metals and metal alloys. The hydrogen gas generated in the reaction chamber 74 exits the chamber 74 as it is produced, and passes first through a liquid/gas separator 77 before entering into the hydrogen container 76, and fuel cell 711 or the like. The liquid/gas separator 77 is made of a porous hydrophobic material with a function to eliminate any liquid from hydrogen stream before it enters the hydrogen line and reaches the container 76 and fuel cell 711. Given that the reaction heat increases temperature in the reaction chamber 74 above the temperature in the hydrogen line, hydrogen can carry more water vapor than required for saturation at the temperature of the gas line. The excess water vapor may condense in the gas line and enter eventually into the fuel cell 711. To eliminate potential problems created by the presence of liquid water in the hydrogen stream, hydrogen may go from the reaction chamber 74 to the waste container 75 first, and after passing through the container 76 to enter into the fuel cell 711. Note that the role of the waste in the container 75 is to cool hot and humid hydrogen and precipitate the excess water.

The hydrogen container 76 is typically collapsible and made of hydrogen impermeable materials such as plastics, or plastic impregnated composites that can withstand the operating pressure, temperature, and chemicals used in the system. A pressure switch attached to the container 76 controls the amount of the stored hydrogen gas and protects the container 76 from being over pressurized. When the pressure exceeds the set point, a pressure switch turns on the fuel cell purge valve (not shown). The reaction waste is removed from the reaction chamber 74 with the pump 710 into the waste container 75 after each reaction is complete. On the other hand, the waste is pumped back into the chamber 74 with a pump 79 before any of the reactants is dispensed. In other embodiment, the one way pumps 79 and 710 may be replace by a single pump (not shown) capable to operate in reverse mode. Typically peristaltic, diaphragm, elastomeric, or any other appropriate pump may be used for pumping the liquid waste in addition to valves combined with flow meters, switches or sensors. The waste container 75 may be collapsible in order to occupy very little volume when empty thus not requiring any delta pressure to be filled up. It is typically made of materials that are chemically, mechanically, and thermally resistant at the system 7 operating conditions. The waste volume pumped into the container 75 after each reaction is equal to the sum of the reactant volumes (solid and liquid) and the waste pumped back into the chamber 74 before each reaction. Since the volume of the waste will increase as much as the volumes of the solid and liquid reactants decrease, the total volume occupied by chemicals in the fuel system 20 will practically stay unchanged. Another advantage of this invention is that the reactants are packed in cartridges and can be replaced easily on the site of the system 20 application.

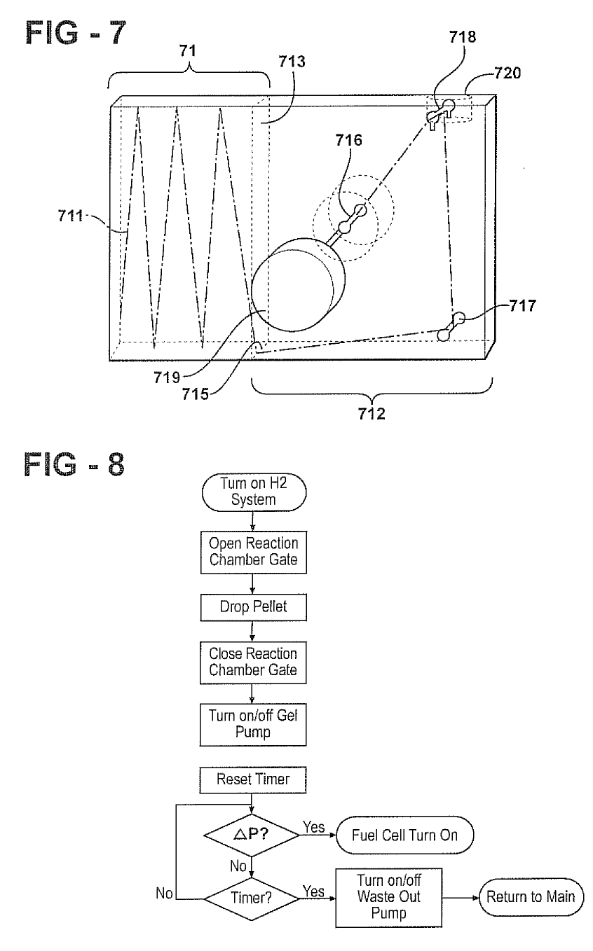

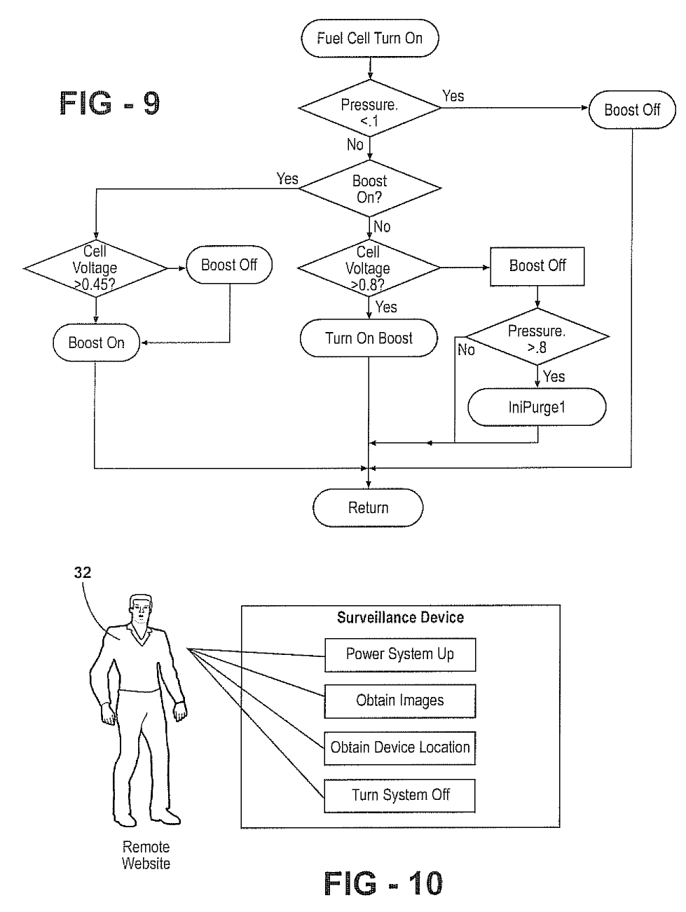

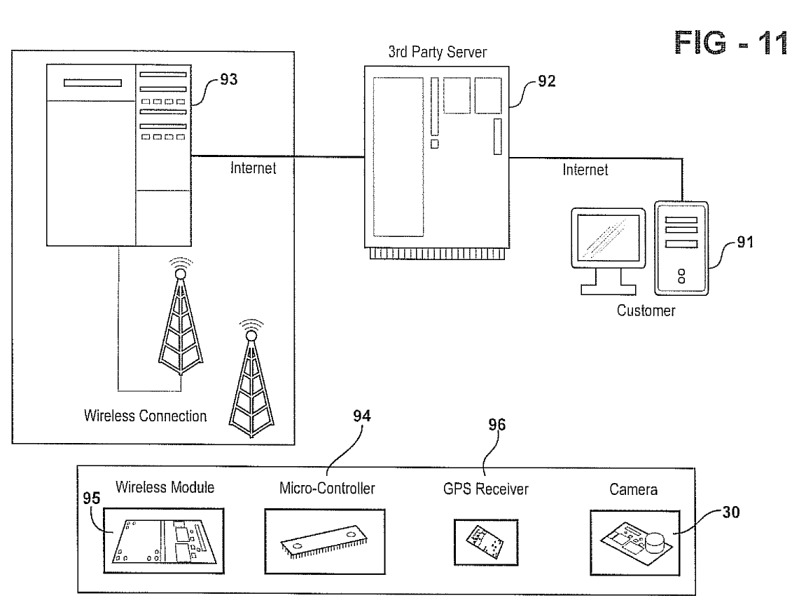

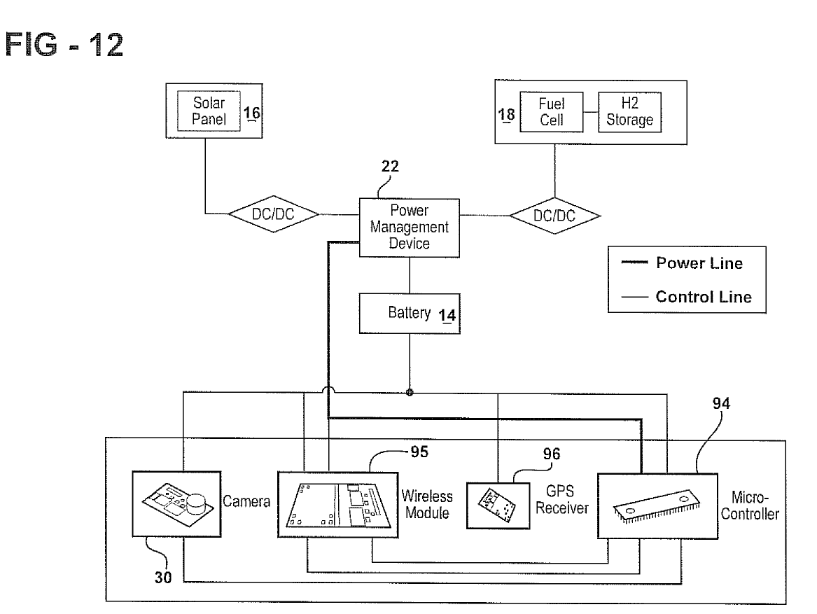

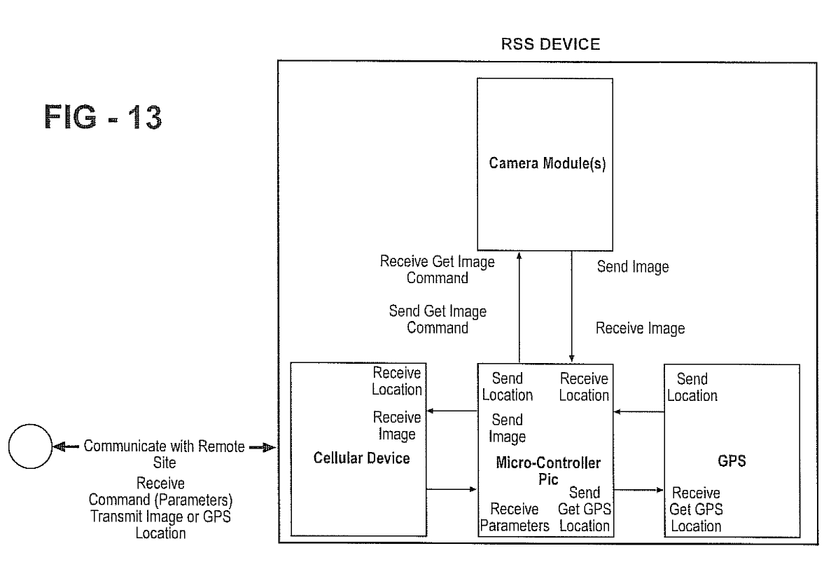

The chemical hydride cartridge 70 is generally shown in FIG. 7. This cartridge embodiment includes both chemical hydride container 71 and dispenser 72 packed in a single box. The container 71 has strip packaged pellets 711 packed in a zigzag formation. They are kept in place with a flat divider 713. The volume of the container may be adjustable to the pellet volume change that decreases with their consumption. The strip packaged pellets 711 exit the container 711 through an outlet port 715 built in the divider 715. The strip 711 is pulled out from the container 71 by a take up spool 716. A rod 717 leads the strip 711 to a dispensing roller 718 and aligns the strip 711 between the outlet 715 and the take up spool 716. When a pellet from the strip package 711 is positioned over the dispensing roller 718 it is released from the strip 711 by slicing the outward laminate web of the strip 711 with a spring loaded knife (not shown). A pellet release mechanism used in this invention may be replaced with different embodiments. The may have knifes for slicing the strip as described in this example, or they may have a sharp wedges for splitting two strip laminated webs. Released pellets fall into a dispensing funnel (not shown) that is functionally connected to the gate vale attached to the reaction chamber 74. The strip package laminate material left after the pellet release is wound on the take up spool 716.

A brushless DC motor 719 interlocks a shaft of the spool 716 creating tension on the strip 711 between the take up spool 716 and the outlet 715. In another embodiment a spool (not shown) may also be utilized as the pellet container 711. A spool may hold the strip package pellets wound around its shaft. A take up spool 716 unwinds the strip 711 from the spool container on the similar way as shown in FIG. 7. The embodiment of the pellet dispenser may stay the same as the dispenser's 72. Once released from the strip package 711, the pellets are pulled into the reaction chamber 74 by gravitation through a gate valve mounted on the top of the chamber 74 and connected to the pellet cartridge 70 via dispensing funnel (not shown). The upper edge of the funnel may fit and seal the cartridge outlet 720. The funnel directs released pellets into a gate valve. A solenoid valve (not shown) opens the gate valve to allow the pellets to enter into the reaction chamber 74, and closes the gate valve before the liquid reactant is pumped in. The fuel system 20 can be turned on manually or automatically by microcontroller. A microcontroller, pressure sensors, and switches incorporated into the power management 22 and sensor boards 24 are utilized to control the operation of the hydrogen system 7. The microcontroller located on the power management board 22 is electrically connected with the pumps 78, 79, and 710, solenoid valve, gate valve, and brushless DC motor 719. It also turns on and of a pressure sensor and switches (not shown). In operation, hydrogen is generated using a solid chemical hydride and liquid glycerol reactant. As an example, sodium brohydride pellets are used as a solid reactant.

When the fuel system 20 is turned on a microcontroller first checks hydrogen pressure and then activates the pellet dispenser 72. It rotates the take up spool 716 until a stop switch (not shown) is activated by a pellet positioned between on the dispensing roller 718 and the cutting device. When the pellet gets into the dispensing funnel, the gate valve opens with a small delay, and the pellet falls into the reaction chamber 74. The dispensing of the liquid reactant and waste starts after the gate vale is closed. The reaction begins as soon as the pellet and liquid get into contact. The reaction is typically slow at the beginning and accelerates over time. The heat generated during the reaction increases the temperature of the reaction mixture and accelerates the hydrogen generation. Hydrogen, waste and water vapor are produced in this reaction. When the reaction temperature in the chamber 74 is higher than the temperature in the hydrogen line between the chamber 74 and hydrogen container 76, the gas is conveyed from the reactor 74 to the waste container 75 to precipitate the excess water from the hydrogen stream. However, if the temperature in the chamber 74 is the same or lower that the hydrogen line leading to the container 76, the hydrogen may go then directly to the container 76 passing firs through a liquid/gas separator 77.

Alternatively, the reaction chamber 74 or reactor receives a hydrogen-generating composition, hereinafter the composition, may be formed outside of the reactor 74 and then introduced into the reactor 74, more typically, individual components that make up the composition are introduced into the reactor 74 and combined at some point in time to form the composition. As such, the reactor 74 generally includes one or more inlets for providing the composition (and/or the components thereof) to the reactor. It is to be appreciated that a portion of the composition can first be formed outside of the reactor 74, such as in an inlet pipe or an outer storage tank, and a remaining portion of the composition can be formed inside the reactor. The reactor 74 typically includes one or more outlets for removing the hydrogen gas from the reactor, during and/or after formation of the hydrogen gas. The outlet (or outlets) can also be used to remove components of the composition, the composition itself, and/or products other than hydrogen gas (e.g. by-products, which are described further below) from the reactor. The inlet and the outlet of the reactor 74 can be one and the same, such as with a batch reactor system, however, the inlet and the outlet are typically different from each other, such as with a semi-batch reactor, a continuous-flow reactor, or other types of batch reactor systems. Flow rates of the inlet and outlet can be controlled by various methods known in the art, such as with pumps and/or valves attached thereto. As such, the reactor 74 may be completely closed off during formation of the hydrogen gas, such as in a batch reaction process, or left partially open during formation of the hydrogen gas, such as in a semi-batch reaction process or continuous-flow reaction process. Depending on the specific reactor system employed, hydrogen can be produced in relatively small to relatively large quantities for later use, or can be produced when required for substantially instantaneous use of the hydrogen.

The composition consists essentially of a borohydride component and a glycerol component. The composition may further include some amount of other components, as described further below, as long as such other components do not hinder formation of hydrogen gas from reaction between the borohydride and glycerol components, which is also described further below. In one embodiment, the composition consists of the borohydride component and the glycerol component.

The borohydride component can comprise one or more conventional borohydrides known in the art. The borohydride component is generally of the simplified formula MBₓH_{y}, wherein M is typically a metal and subscripts x and y are typically integers, more typically subscript x is one (1) and subscript y is four (4). In certain embodiments, the borohydride is selected from the group of sodium borohydride (NaBH₄), lithium borohydride (LiBH₄), potassium borohydride (KBH₄), rubidium borohydride (RbBH₄), and combinations thereof; however, it is to be appreciated that other borohydrides may also be used, as described above. As shown in the formulas above, the borohydride component has hydrogen atoms; typically the borohydride component has four (4) hydrogen atoms. Suitable grades of borohydrides, for purposes of the present invention, are commercially available from a variety of commercial suppliers.

In one embodiment, the borohydride component comprises sodium borohydride, which is also referred to in the art as sodium tetrahydroborate. This embodiment is especially useful because it is believed that the sodium borohydride has the highest specific hydrogen yield with the lowest specific energy release relative to other borohydrides, such as those described and exemplified above. Further, it is also believed that the sodium borohydride has excellent chemical and thermal stability relative to other borohydrides. For example, as understood in the art, sodium borohydride generally melts at ˜400° C., and generally thermally decomposes at temperatures higher than ˜400° C. Further, sodium borohydride is generally soluble in water and methanol; however, sodium borohydride tends to react with both unless a strong base is added to suppress solvalysis, specifically hydrolysis, as described above and as illustrated by Reaction Scheme I. Suitable grades of sodium borohydride, for purposes of the present invention, are commericially avaliable from a variety of commerical suppliers.

The borohydride component comprises borohydride particles of various size and shape. Typically the borohydride particles are in the form of a powder, however, the powder can also be confectioned into larger sizes and shapes, such as granules, beads, and pills. Generally, to facilitate reaction of the borohydride particles, increased surface area of the borohydride particles is preferred relative to borohydride particles having lower surface areas. Specifically, in certain embodiments, the borohydride particles have an average particle diameter of less than about 300 micrometers (μm), alternatively less than about 200 micrometers, alternatively less than about 100 micrometers.

Increased surface area and reduced particle size of the borohydride powder can be achieved by various methods. One example of a suitable method for obtaining higher surface area of the powder is to deagglomerate the borohydride particles by suspending the powder in a carrier fluid (or a non-solvent/hydrophobic media). Specifically, in certain embodiments, the borohydride component further comprises the carrier fluid. As such, when the carrier fluid is employed, the borohydride particles are suspended in the carrier fluid. If employed, the carrier fluid can be any conventional carrier fluid known in the art. Typically, the carrier fluid is selected from the group of mineral oil; petroleum jelly; saturated vegetable, plant, and animal oils and fats; non-saturated vegetable, plant, and animal oils and fats; and combinations thereof. In one embodiment, the carrier fluid is mineral oil. If employed as the carrier fluid, mineral oil can readily be recycled and recharged for subsequent use, as described further below.

Another example of a suitable method for obtaining higher surface area of the powder is to grind the powder. Suitable apparatuses for grinding the powder include, but are not limited to, conventional ball mills, such as planetary ball mills. To prevent the borohydride particles from agglomeration, the powder is typically mixed with surfactants and/or dispersants, and then the borohydride particles are suspended in the carrier fluid, as described and exemplified above. The addition of surfactants and/or dispersants to the powder of the borohydride component also improves distribution of the borohydride particles during reaction thereof, which is described further below. If employed, the surfactant and/or the dispersant may be any type known in the art, and are commercially available from a variety of commercial suppliers.

The glycerol component comprises glycerol, which is also referred to in the art as glycerin, glycerine, propane-1,2,3-triol, propane-1,2,3-triol, 1,2,3-propanetriol, 1,2,3-trihydroxypropane, glyceritol, and glycyl alcohol. As understood in the art, glycerol is generally of the simplified formula C₃H₈(OH)₃. As shown in the aforementioned formula, the glycerol component has hydroxyl (OH) groups, and the hydroxyl groups have hydrogen atoms in addition to other hydrogen atoms of the glycerol. As understood in the art, glycerol is a polyol, specifically a triol or a trihydroxyl alcohol. Generally, glycerol is a colorless, odorless, sweet-tasting, syrupy liquid that melts at ˜17.8° C., and boils with decomposition at ˜290° C. Glycerol is generally miscible with water and other polar solvents. Glycerol is present in the form of esters (e.g. glycerides) in many animal and vegetable fats and oils. Glycerol can be obtained commercially as a by-product of animal and vegetable fat and oil hydrolysis. Glycerol can also be synthesized on a commercial scale from propylene produced by petroleum cracking. Recently, glycerol has been obtained as a by-product of biodiesel production, which has favorable economic and environmental benefits, for purposes of the present invention. Due in part to many avenues of production, glycerol is commercially available from a wide variety of commercial suppliers. Further, cost of glycerol is expected to drop with increases in biodiesel production.

The borohydride component is reacted with the glycerol component. Reaction of the components occurs in the reactor, once the components are contacted. Once the borohydride and glycerol components react, substantially all of the hydrogen atoms present in the borohydride component and substantially all of the hydrogen atoms present in the hydroxyl groups of the glycerol component are converted to form the hydrogen gas. The reaction between the borohydride component and the glycerol is a solvolysis reaction; more specifically the reaction between the borohydride component and the glycerol is an alcoholysis reaction. An example of an alcoholysis reaction between the sodium borohydride (as the borohydride component) and the glycerol is illustrated below by simplified Reaction Scheme II.

3 NaBH₄+4 H₅(COH)₃→4 H₂(g)↑T+(NaB)₃(H₅(CO)₃)₄+heat Reaction Scheme II:

As illustrated by Reaction Scheme II above, the alcoholysis reaction is generally a spontaneous exothermic reaction of the sodium borohydride and the glycerol component that produces hydrogen gas, heat, and a by-product, i.e., a sodium borate complex ((NaB)₃(H₅(CO)₃)₄). In other words, the sodium borate complex is a reaction product of the borohydride component and the glycerol component. The sodium borate complex can be referred to as a metal glycerolate, here as a sodium glycerolate. The reaction product, e.g. the sodium borate complex, can be separated, collected, and sold after forming the hydrogen gas, if so desired. It is important to note that all hydrogen atoms present in the sodium borohydride and all of the hydrogen atoms present in the hydroxyl groups of the glycerol are converted into the hydrogen gas. Specifically, as alluded to above, generally, the alcoholysis reaction of the present invention yields 100% hydrogen from the hydrogen atoms of the borohydride component and the hydrogen atoms of the hydroxyl groups of the glycerol component.

Generally, chemical conversion in the alcoholysis reaction is localized at a phase interface. Specifically, a boundary layer formed at a solid surface of the borohydride particle, e.g. a sodium borohydride particle, consists of a saturated solution of the reaction products, e.g. the sodium borate complex and for a period of time, the hydrogen gas. Limiting factors for the alcoholysis reaction include a diffusion rate of the glycerol component and the size of surface area of borohydride component, as introduced above. Various steps for reducing these limiting factors are further described below.

Theoretical hydrogen storage capacity for the alcoholysis reaction can be calculated based on Reaction Scheme II. In the alcoholysis reaction, the weight of the sodium borohydride is 38 grams/mole, and the weight of the glycerol that reacts with the sodium borohydride is 122 grams (1.33 moles of glycerol per 1 mole of the sodium borohydride), the total reactant weight (i.e., the composition weight) is 160 grams. Since 8 grams (or 4 moles) of hydrogen is released, the theoretical hydrogen storage capacity is calculated as 8 grams over 160 grams, or 5.0% by weight of the composition. To sustain continuous hydrogen formation, three (3) moles of the borohydride component, e.g. sodium borohydride, needs to react with four (4) moles of glycerol, continuously. As such, the composition, prior to reaction, generally includes the borohydride component and the glycerol component in a three (3) to four (4) stoichiometric ratio relative to one another. In certain embodiments, to insure that the borohydride component fully reacts during the alcoholysis reaction, i.e. to insure that the borohydride component is fully “used up”, the glycerol component is present in the composition in a stoichiometric excess relative to the borohydride component, prior to reaction. In other embodiments, the borohydride component and the glycerol component may be in other stoichiometric ratios relative to one another, depending on how much hydrogen formation is desired. It is to be appreciated that a similar alcoholysis reaction with the glycerol component can occur with borohydrides other than sodium borohydride, as described and exemplified above, which will yield a different borate complex by-product, i.e., different metal glycerolates, and different amounts of hydrogen based on their respective hydrogen storage capacity. It is also to be appreciated that the borohydride component can include a combination of two or more of the aforementioned borohydrides.

It is believed that the alcoholysis reaction, as illustrated above by Reaction Scheme II, involves two primary steps to form the hydrogen gas. The first step of the two involves protonation of the borohydride component, which is illustrated below by simplified Reaction Scheme III.

[BH₄]⁻+H₅(COH)₃→H₂BH₃+H₅(COH)₂(CO)⁻ Reaction Scheme III:

As illustrated above by Reaction Scheme III, the first step involves protonation of the borohydride component with a proton from the glycerol component. It is believed that in the presence of a strong basic group such as a borohydride anion (i.e., the [BH₄]⁻ of the borohydride component), the glycerol component behaves as a Lewis acid and can lose protons from its hydroxyl groups. It is further believed that the proton from the glycerol component creates an unstable intermediate (i.e., BH₂BH₃). [0090] The second step of the two involves formation of hydrogen, as illustrated below by simplified Reaction Schemes IV and V.

H₂BH₃→H₂(g)↑+BH₃ Reaction Scheme IV:

BH₃+H₅(COH)₃→H₂(g)↑+BH₂[H₅(COH)₂(CO—)] Reaction Scheme V:

As illustrated above by Reaction Scheme IV, the unstable intermediate decomposes into a hydrogen molecule and an unstable borohydride (i.e., BH₃). This unstable borohydride may further deprotonate another molecule of the glycerol component creating an additional hydrogen molecule and a boron glycerolate complex (BH₂[H₅(COH)₂(CO—)]) as illustrated above by Reaction Scheme V.

It is believed that both of the hydrogen forming steps of the second step illustrated above in Reaction Schemes IV and V are fast relative to the first step illustrated in Reaction Scheme III. It is believed that the difference is reaction rate is due predominantly to the presence of the unstable intermediate compounds (H₂BH₃ and BH₃). As such, the first step is the rate determining step for the overall alcoholysis reaction of the present invention. The practical meaning of the first step is that by changing the rate of this first step, the overall reaction rate of the alcoholysis reaction changes, thereby resulting in different hydrogen generation rates. Various methods of changing the rate of the alcoholysis reaction, i.e., a rate of formation of the hydrogen, are described and illustrated below.

The reactor can have its temperature altered, the composition can have its temperature altered, or both the reactor and the composition can have their temperatures altered. Temperature of the composition may be adjusted by heating or cooling the composition itself, and/or by heating or cooling an individual component (or components) thereof prior to forming and/or during formation of the composition. It is to be appreciated that one or more of the components may be heated and/or one or more of the components may be cooled prior to forming the composition. By altering temperature, the rate of formation of the hydrogen gas can be adjusted.

Generally, increasing the temperature increases the rate of formation of hydrogen, while decreasing the temperature decreases the rate of formation of the hydrogen. Heating and cooling can be accomplished by various methods known in the art, such as by the use of one or more heat exchangers. For example, the reactor may include a heat exchanger to control its temperature or a storage vessel containing one of the components, e.g. the glycerol component, can include a heat exchanger.

Viscosity of the composition can also be altered by heating or cooling the composition, as described and exemplified above. Generally, heating the composition decreases viscosity of the composition and cooling the composition increases viscosity of the composition. Typically, increasing the viscosity decreases the rate of formation of the hydrogen and decreasing the viscosity of the composition increases the rate of formation of the hydrogen, by increasing the diffusion rate of the glycerol component. For example, an increase of temperature from 20° C. to 40° C. causes viscosity of the glycerol component to drop by almost a factor of 5 (e.g. dropping from ˜1,410 centipoise to ˜284 centipoise). Alternatively, the viscosity of the glycerol component can be changed by dilution of the glycerol component. Examples of suitable diluents, for purposes of the present invention, include water and alcohol. However, any other diluent known in the art that has lower or higher viscosity than the glycerol component and is miscible with the glycerol component can be used to modify the viscosity of the glycerol component. In certain embodiments, the method further comprises the step of providing a surfactant component to the reactor thereby altering viscosity of the hydrogen-generating composition. If employed, the surfactant component can comprise any type of surfactant known in the art. As described above, the borohydride component may already include a surfactant to prevent agglomeration of the borohydride particles. Suitable surfactants, for purposes of the present invention, are available from a variety of commercial suppliers.

Pressure can be altered by various methods known in the art, such as by changing flow rates of the components fed to the reactor, changing flow rates of products removed from the reactor, e.g. the hydrogen, or by changing a volume within the reactor. Altering pressure in the reactor is useful for adjusting the rate of formation of the hydrogen. Generally, increasing pressure in the reactor increases the rate of formation of the hydrogen and decreasing pressure in the reactor decrease the rate of formation of the hydrogen.

The method can further comprise the step of providing a pH component to the reactor. The pH component can be provided separate from the borohydride and glycerol components, or included with one of or both of the borohydride and glycerol components. The pH component is useful for adjusting the rate of formation of the hydrogen gas. The pH component can comprise at least one of an acid, a base, and a buffer. The acid, base, or buffer can comprise any acid, base, or buffer known in the art. Generally, the acid, base, or buffer respectively increases, decreases, or maintains the rate of formation of the hydrogen gas. Suitable acids, bases, and buffers, for purposes of the present invention, are available from a variety of commercial suppliers.

In one embodiment, the pH component comprises acetic acid, which can be concentrated or diluted, e.g. 5% by weight acetic acid in water. This embodiment useful for increasing the rate of formation of the hydrogen gas. Typically, the borohydride component will react with the acid, if employed as the pH component. In such a reaction, generally hydrogen gas and triacetoxyborohydride (NaBH(CH₃COO)₃) are formed (when sodium borohydride is employed as the borohydride component). Such a reaction between the borohydride component, e.g. sodium borohydride, and the acid is also generally highly exothermic. As such, heat generated during such the exothermic reaction can be used to trigger the alcoholysis reaction since the reaction rate of the alcoholysis reaction can be suppressed or enhanced by changing temperature, as described and exemplified above. If employed, the pH component can be used in various amounts, based on how much the rate of formation of hydrogen is desired to be changed. As such, suitable amounts of the pH component and corresponding rates of reaction can be determined via routine experimentation by one skilled in the art.

The method can further comprise the step of providing a catalyst component to the reactor. The catalyst component can be provided separate from the borohydride and glycerol components, or included with one of or both of the borohydride and glycerol components. The catalyst component is useful for adjusting the rate of formation of the hydrogen gas, typically, if employed, for increasing the rate of formation of the hydrogen gas. It is believed that the catalyst component facilitates heterogeneous catalysis of the alcoholysis reaction. The catalyst component can comprise one or more conventional catalysts known in the art. Suitable grades of catalyst, for purposes of the present invention, are available from a variety of commercial suppliers.

If employed, the catalyst component is typically a solid catalyst. The catalyst component can be in various forms, such as a finely dispersed powder, pellets, or particles. These forms of the catalyst component can be suspended in the glycerol component (i.e., the glycerol component serves as a carrier fluid). The catalyst component is typically selected from the group of carbon-based catalysts, platinum-based catalysts, palladium-based catalysts, ruthenium-based catalysts, titania-based catalysts, and combinations thereof. In one embodiment, the catalyst component comprises activated carbon. This embodiment useful for increasing the rate of formation of the hydrogen gas. Further, activated carbon is generally inexpensive, bio-derived, and bio-degradable. Specifically, low catalyst cost and preparation from renewable sources allows for discarding of the activated carbon along with the reaction by-product or recycling of the activated carbon by filtration, washing and drying. If employed, the catalyst component can be used in various amounts, based on how much the rate of formation of the hydrogen is desired to be changed. As such, suitable amounts of the catalyst component and corresponding rates of reaction can be determined via routine experimentation by one skilled in the art.

The method can further comprise the step of recycling the carrier fluid (if employed, as previously described and exemplified with description of the borohydride component) from the reactor after the step of reacting the borohydride component with the glycerol component. This step is useful for incorporating additional borohydride particles into the recycled carrier fluid. As such, the “recharged” and recycled carrier fluid can be subsequently used for providing additional amounts of the borohydride component to the reactor for further formation of hydrogen. A semi-batch reaction system employing such a step is described below.

In certain embodiments, the method further comprises the step of providing water to the reactor 74. The water is useful for diluting the hydrogen-generating composition. Further, the water can also react with the borohydride component to form hydrogen; however, such a reaction is generally disfavored due to issues with increase in pH and fouling of the catalyst component, as described above. As such, in certain embodiments, the composition is substantially free of water. In these embodiments, the composition typically includes water in an amount of less than 50, more typically less than about 25, yet more typically less than about 15, most typically less than about 5, and yet most typically equaling or approaching about 0, parts by weight, based on 100 parts by weight of the composition. It is to be appreciated that one or more of the components may include trace amounts of water. In one embodiment, the composition is completely free of water, i.e., the composition is anhydrous.

The method can further comprise the step of mixing the composition contemporaneously with the step of reacting of the borohydride component with the glycerol component. This step of mixing is useful for increasing a rate of formation of the hydrogen gas. Specifically, the diffusion limitations of the alcoholysis reaction can be reduced through mixing, stirring, or physical manipulation of the composition such that convective mass transport becomes a dominating flow effect. Generally, mixing greatly enhances the rate of reaction of the glycerol component with the borohydride component. Mixing of the composition can be accomplished in various ways, such as by a mixing blade disposed in the reactor or by some other form of agitation known in the art. For example, the components can be mixed via spraying when being introduced into the reactor. Further, mixing can be achieved not only through external means, e.g. a mixing blade, but also by taking advantage of temperature generation to promote natural convection of the composition within the reactor.

Generally, the method further comprises the step of removing the hydrogen gas from the reactor after (and/or during) formation of the hydrogen gas. Also, the method generally comprises the step of storing the hydrogen gas removed from the reactor. The hydrogen gas can be stored in a storage vessel or stored directly in an end product, such as a hydrogen fuel cell.

As introduced above, various types of reactors, and therefore various types of reactor systems can be employed to employ the present invention. In one embodiment, the reactor is a batch reactor. In this embodiment, as introduced above, stoichiometric quantities of the components of the alcoholysis reaction are provided to the reactor at the same time to form the composition. Batch reactors allow for the alcoholysis reaction to be completed, albeit at a decreasing rate in time.

The operation of the system 10 is entirely managed and controlled with power electronics mechanically supported and electrically connected on three printed circuit boards, such as the data management board 26, the power management board 22, and the sensor board 24. The power electronics provides the proper functioning of the system 10 that ensures its reliable stand alone operation for the designed operating time. The main functions carried out by the power electronics are the power management of the hybrid power system, the controls and management of the fuel production, and the wireless data transmission. The power electronics includes various sensors, DC/DC converters, power conditioners, data modules, microcontrollers, and other electronics elements that provide their proper operation.

The power management board 22 and the sensor board 24 are generally shown. They are electrically connected to the other components of the system 10 presented in this invention. The power management board 22 and the sensor board 24 are designed to manage and control the operation of the hybrid power system that provides the power necessary to operate the system 10. The power management board 22 is electrically connected with the higher voltage electrical lines to the battery pack 14, the solar panel 16, and the PEM fuel cell 18. However, the lower voltage electrical lines connect this board 22 to the data management board 26, sensor board 24 and fuel system 20. The power management board 22 supports and electrically connects a microcontroller (MCU), DC/DC synchronous converters, amplifiers, and sensors. The MCU has several inputs and outputs that are programmed to perform different functions. These functions may include turning off and on switches and transistors that are the electrical connection with the battery pack 14, the solar panel 16, and PEM fuel cell 18. It may also convert the electrical signals into digital via analog to digital converter (A/D). This way the MCU is able to measures temperature, voltage, and current in the system 10 and to make decisions based on the state of each input. The synchronous DC/DC converters utilized in the system 10 are step-up (boost) converters, and step-down (buck) converters. The DC/DC converters are electrically connected to the MCU on the power management board 22. A boost DC/DC converter interfaces the fuel cell with the battery. This converter is directly connected to the MCU to regulate the voltage and the amount of current sent from the fuel cell to the battery. The MCU practically adjusts the duty cycle of the converter (time off and time on) based on the battery state of charge and hydrogen pressure in the container 76. The voltage is used as reference to regulate the power delivered to the battery pack 14. The DC/DC convert used to interface the solar cell 16 with the battery pack 14 has Maximum Power Point Tracking (MPPT) system in order to increase the conversion efficiency. This converter is a buck type DC/DC converter used to step down the power voltage supplied to the battery during recharging. Three additional buck DC/DC converters which feeds the power from the battery pack 14 to the sensors board 24, the data management board 26, and the camera devices 30 at decreased voltages. The synchronous DC/DC converters have higher efficiency in voltage conversion. They are transistors, typically Mosfet type, used to modify output voltages.

Amplifiers included on the power management board 22 intensify voltage signals. The amplifiers used have adjustable gains in order to increase the resolution of the A/D ports in the MCU. In addition, they can precisely measure the small fluctuations of voltages. The sensor board 24 mechanically supports and electrically connects sensors such as temperature, pressure, current, voltage, and position switches. The board 26 also incorporates a second microcontroller (MCU 2). The main functions of the MCU 2 are to monitor all signals received from the sensors and to ensure maximum efficiency and reliability of the power system. It sends/receives electrical signals to/from the fuel cell, the battery, and fuel system. The sensor board 24 receives the electrical power from the power management board 24 at the voltages required for its components to appropriately operate. The board 22 monitors the voltages of the fuel cell stack, and battery, the current in and out of the battery, the pressure in the hydrogen container 76, and the temperature of different components of the system 10. The sensor board 24 ensures that all power management components work at predetermined values. The system 10 power management operation includes voltage regulation to or from the battery pack with DC/DC converters. The system utilizes three buck converters which feed power from the battery to the microcontroller, sensors, cameras, and the wireless transceiver module in the data management board 26. The remaining converter which is of the boost configuration interfaces the fuel cell system with the battery pack. This later converter is connected to the microcontroller to regulate the voltage and the amount of current from the fuel cell to the battery. This is accomplished by adjusting the duty cycle that determines for how long the converter is on. The time the converter is on is adjusted by the MCU, which determines the best duty cycle depending on the state of charge of the battery and hydrogen pressure in the container 76. This way, the fuel cell does not charge the battery at a rate that could potentially damage the battery pack 14. The MCU sets up the converter, so the fuel cell can work at the maximum efficiency delivering power to the electronics and charging the battery pack 14. The sensors that measure temperature, pressure, and tilt ensure that the hydrogen generator as well as the fuel cell does not reach high temperatures. The pressure sensor measures the pressure in the hydrogen vessel to know the amount of hydrogen and prevent an overpressure.

A long term independent operation of the current invention is achieved is achieved by synchronizing the operation of the fuel cell and hydrogen production in fuel system 20 with the state of the charge of the battery. This operation includes very complex system management and controls procedure. The most important step in this procedure is the constant monitoring of the battery charge. The level of the battery charge determines what the next step is. If the battery state of charge has dropped to a predetermined threshold, the PEM fuel cell system is activated by turning on both the PEM fuel cell and fuel system 20 in the case that the hydrogen pressure in the container 76 is below the predetermined pressure. A are the partial flow charts of the whole procedure for turning on the fuel system 20 and the fuel cell. The steps listed below are the examples of the controls strategy used in the hydrogen generation process. The steps may include the following pattern, wherein the reaction chamber is opened then pellets are dropped into the chamber and then the reaction chamber is closed. Waste and gel are pumped into the reaction chamber. Then, hydrogen pressure increases to the predetermined value when hydrogen pressure is at the threshold level, the fuel cell is turned on. Once the hydrogen reaches the predetermined pressure, MCU 2 on the sensor board 24 checks the voltages of individual cells in the fuel cell stack 18. If the cell voltages are not high enough, then hydrogen is purged. These two steps are repeated until the cell voltages reach the predetermined values. Since the controls procedure of the fuel cell operation is more complex and involved factor related to the other component of the system 10

The system 10 is wirelessly connected to a user via cellular network. The wireless connection allows the system user 32 to perform four major functions as illustrated in: obtain images, obtain device location, turn system off and turn system on. All basic components of the wireless infrastructure generally required to communicate with the system 10 remotely may include a user internet connection 91, a third party server 92, a cellular wireless network 93, a microcontroller 94, a wireless module 96, a global positioning system (GPS) receiver 96, and the cameras 30. The cameras 30 are optional, and are present only for the surveillance purpose. They may be replaced by any other type of sensing device. The microcontroller 94, the wireless module 96, and the GPS 96 are located on the data management board 26. These components provide the system 10 connection to the cell wireless network 93.

The wireless module 95, the GPS receiver 96, and the cameras are electrically connected to the microcontroller 96 that controls their operation. On the other hand, the electrical power is supplied to each component through direct connection with the power management board 22. The system user 32 may communicate with the device when located remotely via internet connection 91 provided by various means such as cell phone or personal computer. The requests for data are sent to a web server 92 that responds to the user by forwarding the requested data. A web server in general is a program that runs on a computer. The computer that a web server 92 resides on is typically called a web host. A web server delivers web pages to computer browsers that requests data from it. It also receives data from its clients. Every web server has an IP address (domain name) to communicate with the clients. When used in this invention, the web server 92 receives data transmitted across the wireless network from the system 10. A database that is able to store the images and GPS coordinates generated by the system 10 are placed on the web server 92. Once the system user 32 wants to view the images and GPS coordinates, the browser will send the requested data to the web server first and then to the user. The web server 92 can be hosted in-house or by a third party. Security and reliability are two major factors that affect the selection of a web host. The wireless cellular network 93 is a radio network made up of a number of cell sites (base stations) that contain fixed transmitters used to provide radio coverage over wide areas. There are two types of cellular network technologies currently available: Global System for Mobile Communications (GSM) and Code Division Multiple Access (CDMA). The 10 may use any of the technologies currently available for the wireless data transmission, even though it is not limited by them since more superior technologies may emerge in the future that may be applicable in the device. The preferred system 10 embodiment includes CDMA wireless technology to provide faster data transmission. This advantage of the CDMA is based on spreading data out over the channel once it is digitized. This way the multiple calls are overlaid across the entire channel, with each having assigned a specific sequence code to keep the high signal resolution. The CDMA's 1x RTT (single carrier radio transmission technology) high-speed technology, has capability to provide Integrated Services Digital Network (ISDN)-like speeds as high as 144 Kbps (kilobits per second). In addition, CDMA network has more capacity for data transmission. CDMA also has broader coverage especially in the United States. On the other hand, GSM has improved speed by introducing Enhanced Data rates for GSM Evolution (EDGE) technology. However, it still has some limits in the aerial coverage. The cellular wireless module 95 establishes a wireless connection between the microcontroller 94 of the system 10 and the wireless network 93 in order to transmit data. When used in the system 10, the selected wireless module 95 fulfills the following criteria: Able to be controlled by receiving AT commands; Able to be activated by a wireless network provider; Able to perform M2M (machine to machine) connection that in this case is a TCP/IP (Transmission Control Protocol/Internet Protocol) stack is built into it.

A separate GPS receiver 96 may be integrated into the data management board 26 of the system 10 in which case the GPS receiver 96 will capture the system 10 coordinates and send them to the microcontroller 94 which in tern will forward them to the cellular module 95 to wirelessly transmit. In addition, the cellular module 95 may have the GPS receiver 96 as an integral part. In this case the wireless module has dual function; it transmits data and receives the GPS coordinates. The Digital cameras 30 are used for the purpose of generating imagines by the system 10. They may have Charge Coupled Device (CCD) or Complementary Metal Oxide Semiconductor (CMOS) technology for capturing images. Each of these technologies may be used for the system 10 due to their unique advantages that may be appropriate for the certain applications of the system 10. For example, CMOS type cameras may be used in the system 10 since inexpensive, and consume low power. In addition they may have a microprocessor included to compress the digital image into a compressed image file such as JPEG (Joint Photographic Experts Group). This way the size of the picture file is significantly reduced permitting the faster data transfer from the microcontroller 94 to the web server 92. The microcontroller 94 located on the data board 26 is in charge of manipulating the incoming and outcoming data from the wireless module 95, the GPS receiver 96, and the cameras 30. It is a microprocessor, self sufficient and cost effective.

Alluding to the above, there are many commercially available microcontrollers that will perform the function of controlling the camera, GPS receiver, and cellular module. Preferred characteristics for the microcontroller to be used in the system 10 are size, robustness, programmability, power consumption, and ability to communicate with both the camera 30 and the cellular wireless module 95. The microcontroller 94 keeps track of time, and sands timed pictures. Additionally, the microcontroller 94 needs to store the images generated by the cameras 30 before they are transmitted. An external memory module may be incorporated into the data management board 26 not shown is used as an additional memory for saving images and GPS coordinates. A preferred type of the memory module is Static Random Access Memory (SRAM) that features a high speed data transfer. For the main function of the system 10, the microcontroller 94 is programmed as the main controller that sends commands to the other devices placed on the data management board 26. The top level functions are programmed into the microcontroller in order to be able to communicate with the cameras 30, the GPS receiver 96, and the wireless module 95. In the operation, the microcontroller receives a request from the wireless module 95 as a Short Message Service (SMS), often called text messaging to open a communication TCP/IP channel for the web server 92. The connection TCP/IP refers to Transfer Control Protocol/Internet Protocol and is typically used to establish communication between an internet user and a web host. Once the communication TCP/IP channel is established, the microcontroller 94 receives commands from the web server 92. For the system 10 the commands may include: take a picture, get GPS coordinates, change time for taking picture, turn off a camera, etc. Upon task completion, the microcontroller 94 stores data and then sends them to the web server 92 via TCP/IP.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A camera system for capturing images and wirelessly transmitting the images to a user, said camera system comprising:
at least one camera device for capturing images;
a data management board for receiving the images captured by said at least one camera for wirelessly transmitting the images to the user;
a fuel system operatively communicated with said data management board and said at least one camera, said fuel system generating power containing by a hydrogen-generating composition consisting essentially of a borohydride component and a glycerol component in a generally three to four stoichiometric ratio, said borohydride component having hydrogen atoms and said glycerol component having hydroxyl groups with hydrogen atoms, said borohydride component reacting with said glycerol component thereby converting substantially all of said hydrogen atoms present in said borohydride component and substantially all of said hydrogen atoms present in said hydroxyl groups of said glycerol component to form the hydrogen gas.

2. A camera system as set forth in claim 1 wherein said borohydride component comprises sodium borohydride (NaBH₄).

3. A camera system as set forth in claim 2 wherein said hydrogen-generating composition is substantially free of water.

4. A camera system as set forth in claim 1 wherein said borohydride component is selected from the group of sodium borohydride (NaBH₄), lithium borohydride (LiBH₄), potassium borohydride (KBH₄), rubidium borohydride (RbBH₄), and combinations thereof.

5. A camera system as set forth in claim 1 wherein said fuel system is further defined by a fuel cell.

6. A camera system as set forth in claim 1 wherein said fuel system further includes a chemical hydride container and a chemical hydride dispenser.

7. A camera system as set forth in claim 1 wherein said reaction chamber is operable connected to outlet port of said chemical hydride dispenser.

8. A camera system as set forth in claim 1 including a chemical hydride container, a chemical hydride dispenser, a liquid reactant container, a liquid-gas separator, and a hydrogen overflow container, and a waste container at the same time.
